(19) United States
(12) Patent Application Publication
(10) Pub. No.: US 2011/0315756 A9
(43) Pub. Date: Dec. 29, 2011

(54) READING DEVICE

(76) Inventors: Lilach Furman, Petah Tikva (IL); Efrat Feinberg, Herzelia (IL)

(21) Appl. No.: 11/384,328

(22) Filed: Mar. 21, 2006

Related U.S. Application Data
(63) Continuation of application No. PCT/IL2004/000878, filed on Sep. 22, 2004.

(30) Foreign Application Priority Data
Sep. 22, 2003 (IL) 158,048

(51) Int. Cl. G06Q 99/00

(52) U.S. Cl. 235/375

(57) ABSTRACT

A reading device comprises a handle or Grabbing surface, a labels identification head and means for outputting an audio sequence corresponding to each label being identified. The label has bi-dimensional distinguishing features. The identification head includes a bi-dimensional sensors array adapted to read the distinguishing features in the label without scanning, when the device is placed over the label. A reading device comprises a handle for easy and ergonomic grabbing by a child's hand, an identification head located in the lower part of the device, for identifying each label when the identification head is placed over the label without scanning and audio generating means for generating predefined sounds for each identified label.

### CROSS-REFERENCE TO RELATED APPLICATIONS

The present application is related to, and claims priority from, the patent application No. 158,048 filed on 22 Sep. 2003 in Israel, and the PCT application No. PCT/IL 2004/000878 filed on 22 Sep. 2004, both filed by the present inventors and entitled “Reading device”.

### FIELD OF THE INVENTION

This invention relates to systems and methods for providing an audio output. The invention relates in particular to such devices for performing a preprogrammed audio sequence responsive to a label attached to a text or book or printed therein.

### BACKGROUND OF THE INVENTION

At present, a problem with little children is to attract them to read books. Reading requires an effort on their part, and may appear to be less interesting than toys or TV computer games.

Prior art devices use bar codes attached to text to activate sound-generating devices. Such devices have various disadvantages, for example they may be difficult to use by small children. It may be difficult to teach children to perform the scanning action along a bar code. The laser head of the barcode reader may be dangerous to kids (when projected into the kid's eyes).

### SUMMARY OF THE INVENTION

It is an object of the present invention, among others, to overcome deficiencies in the prior art as noted above.

This object is achieved by an improved automatic page reader for children.

The books are made more interesting to the little child, with music and voice enlivening the printed text.

The child also learns patterns recognition and matching, wherein he/she searches for the label on each pages and places the reading device over it.

Moreover, the movement and coordination skills of the child are improved, as he/she flips the pages of the book and uses the device with the book.

According to one aspect of the invention, the new device includes means for generating a preprogrammed audio sequence, when the device is brought into proximity with a specific label. Thus, a plurality of labels may be attached each to a page in a book, and the device will generate a specific audio sequence for each label encountered there.

The audio sequence may include a narrative of the text in that page, a related song, a musical performance or a combination thereof.

Label identification without scanning: The label preferably has a bi-dimensional shape, with corresponding electro-optical sensors in the device, to enable label identification without a lateral movement of the device—no scanning is required.

Thus, the child just places or points the device on the label; the device identifies the label and performs the audio part related to that label.

The device is programmable, to allow flexible use—audio for new books can be loaded into the device as desired, to update it.

Existing books can be adapted for use with the reading device, by sticking labels on each page and loading a file with audio for that book.

Alternately, new books can be printed with labels on each page, to allow using a book with the new reading device of this invention.

Audio files in conjunction with labels sets can be sold at bookstores or may be downloaded from the Internet, for example.

Preferably, the shape of the reading device is made to correspond with that of the label, or vice versa—it is thus easy for a little child to understand intuitively how to match the two, reading device to label, by placing the device over the label in order to hear the music or the story related to that page.

Throughout the present disclosure, it is to be understood that the labels may either be attached to a text or book or printed therein.

Further objects, advantages and other features of the present invention will become obvious to those skilled in the art upon reading the disclosure set forth hereinafter.

### BRIEF DESCRIPTION OF DRAWINGS

The above as well as other objects and advantages of the present invention will become more apparent from the following detailed description of the structure and method of operation of the invention, which are explained in detail below by way of example of preferred embodiments, taken in conjunction with drawings, wherein:

FIG. 1 illustrates a book with labels placed on each page.

FIG. 2 details a reading device being placed on a label in a book page.

FIG. 3 details the upper part of the reading device.

FIG. 4 illustrates the reading device being misplaced over the label.

FIG. 5 illustrates the reading device being correctly placed over the label.

FIG. 6 details a block diagram of the reading device

FIGS. 7 to 12 detail example of labels.

### DETAILED DESCRIPTION OF THE PREFERRED EMBODIMENTS

A preferred embodiment of the present invention will now be described by way of example and with reference to the accompanying drawings.

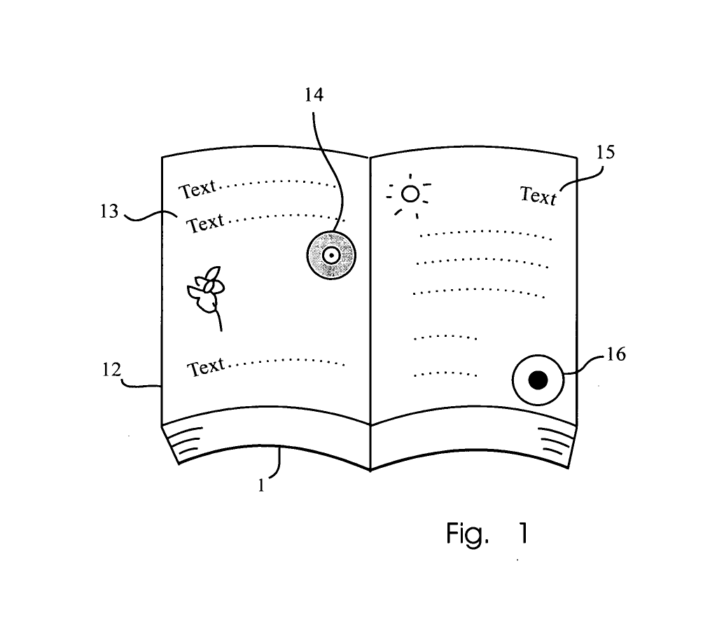

FIG. 1 illustrates a book 1 with labels placed on each page. A page 12 in book 1 includes text, drawings and/or pictures 13 and also a label 14. The label 14 has unique characteristics, distinguishing it from other labels in the book—unless the same audio/voice/music is to be performed for several pages, in which case several pages may use the same label.

Another page 15 has a different label 16—for example a different color combination of the rings there. The difference between labels may include different colors, different shades of gray between white and black, etc. Various optical characteristics may be used, with reader means having sensing means suitable means, capable of reading these characteristics. The differences may lay in the infrared or ultraviolet range, with suitable sensor means in the reading device.

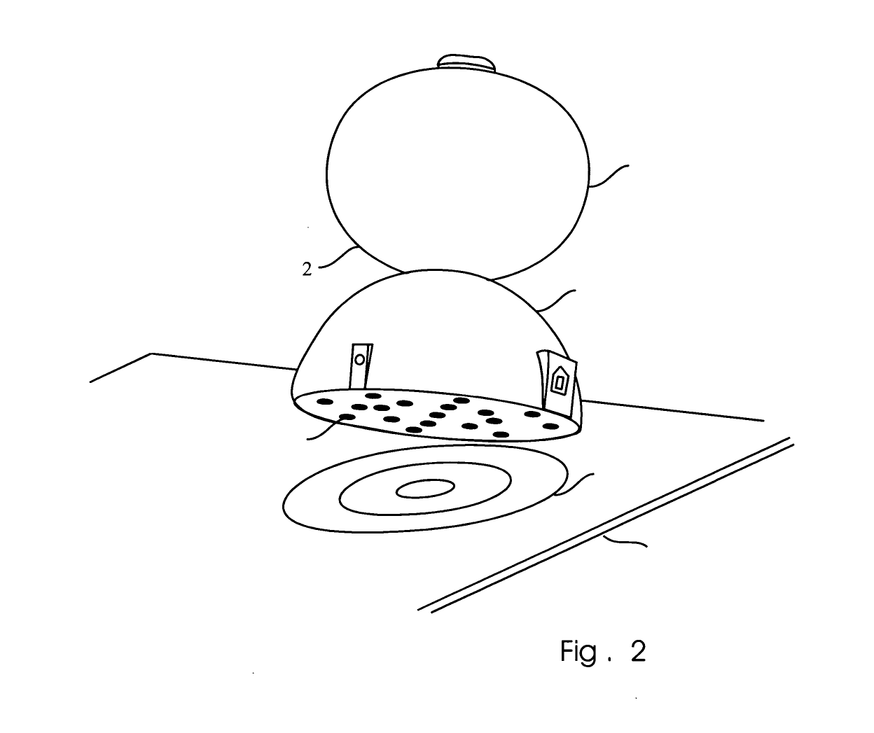

FIG. 2 details a page reading device 2 being placed on a label 14 in a book page 12. The lower part of the device 2 is placed closed to a label 14. As can be seen in FIG. 2, they have the same mechanical shape, round in this case.

This is an example of a preferred embodiment of the reading device 2, including a Handle/Grabbing surface 21 that is designed for easy handling by the user (the top part), in this case the top part also contains the HMI (speaker, microphone, button, LED, LCD, etc.) The Body of the apparatus 22 is the lower part, it may contain things like the electro-optical sensor array, battery, electronic cards, USB and headset connector.

The electro-optical sensor array may use holes or a transparent surface in the base 23 of the lower part of unit 22. The sensor array is bi-dimensional, adapted to read bi-dimensional labels without scanning.

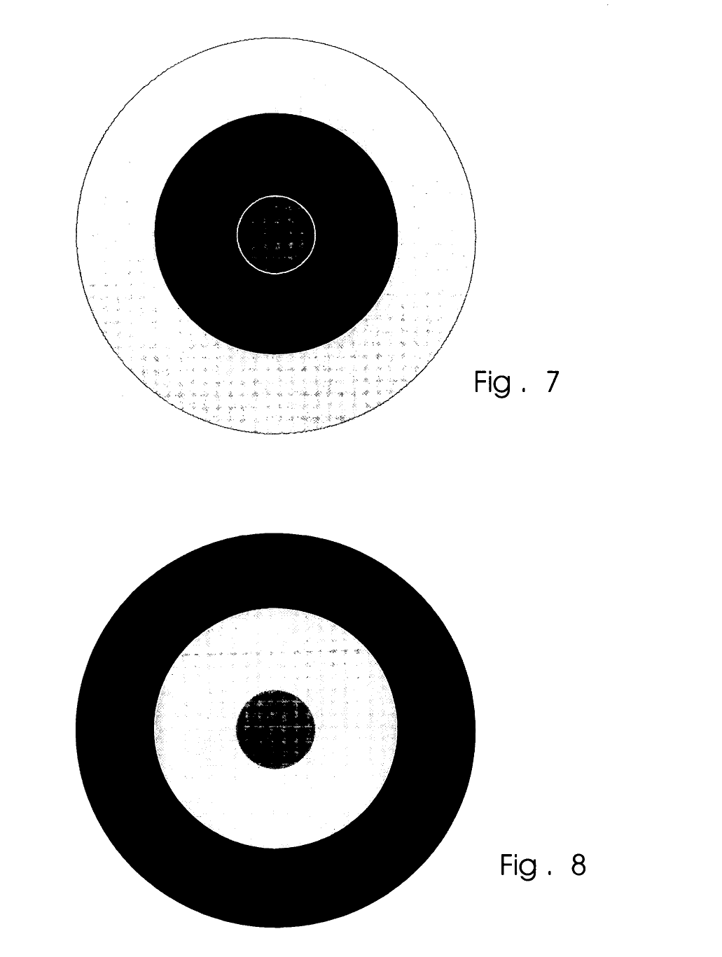

The base of unit 22, round in this case, is compatible with round-shaped labels such as that illustrated in FIGS. 7 and 8. It is flat and contains sensors for things like label identification, darkness, ultrasonic sensor or others.

The reading device 2 is preferably a small and compact apparatus, intended to be held and operated by a child. The Apparatus is a Portable Handheld device, packaged in a rugged plastic package, enabling it to withstand the environmental conditions which are typical for Children behavior and surrounding such as vibrations, falling on the ground, throwing the device against the walls, etc.

The reading device 2 may include the following three main elements:

A. Handle/Grabbing surface 21

B. Lower part 22, including a Labels Identification Head.

C. Body (optional)

The parts detailed:

A. Handle/Grabbing surface 21—Intended for easy and ergonomic grabbing by a child's hand, in such a way that will enable easy and straightforward activation of the apparatus functions by the child.

B. Identification Head in the lower part 22—The apparatus has a flat Head, having the typical label's shape in such a way that will enable to place the head against the surface in which the label is placed in a Matching format. The Identification Head will include all the applicable sensors in such a way that will enable to identify the specific label in an unambiguous manner. The Head may have a symmetric shape such as a Circle but is not restricted to any kind of shape, either symmetrical or asymmetrical.

C. Body—This is the main part of the apparatus which connects between the two mentioned parts. The body may include all the applicable electronics including the battery, speaker, microphone, USB connector and all the HMI elements.

Alternately, there are the two parts 21 and 22 as illustrated, with the components of part C packed within these parts according to engineering considerations.

In another embodiment, one body includes the above parts 21, 22, 23.

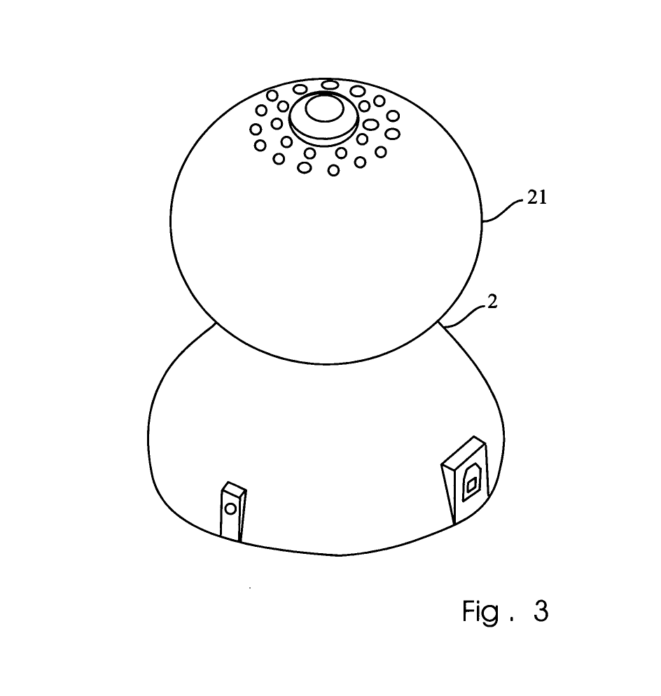

FIG. 3 details the upper part 21 of the reading device 2.

FIG. 4 illustrates the reading device 2 being misplaced over the label 14. The apparatus is not placed directly on the Identification Label 14. The tolerance of the system and the identification algorithm will either enable a valid detection if possible, or no detection at all if not.

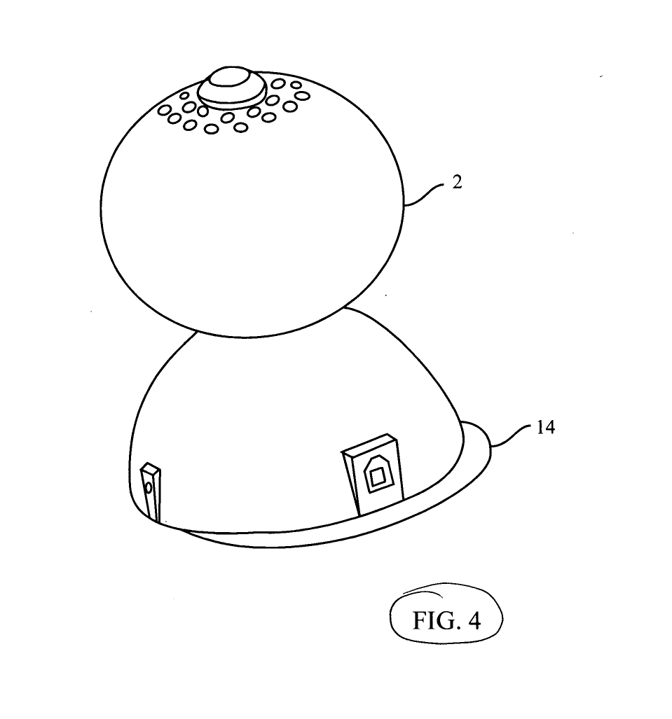

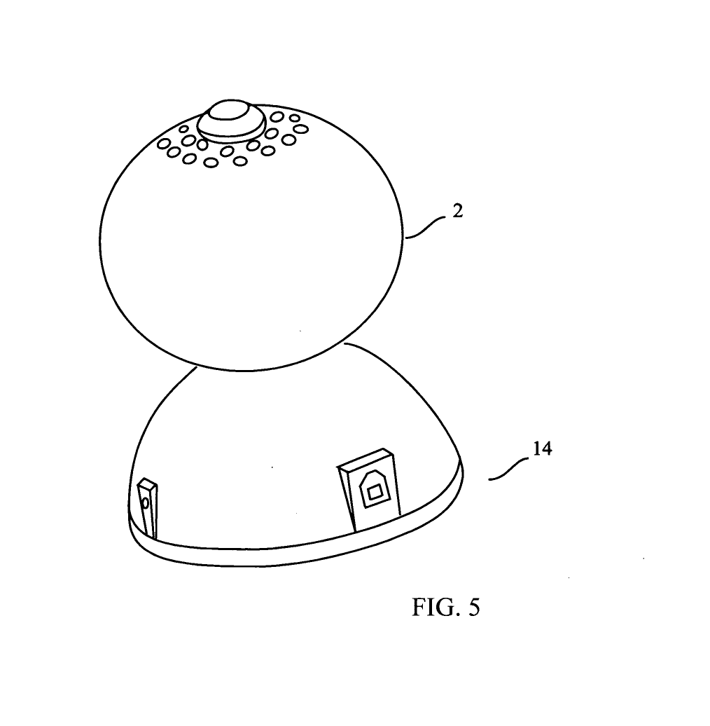

FIG. 5 illustrates the reading device 2 being correctly placed over the label 14.

The apparatus is placed directly on the Identification Label 14. This will result in identifying the label and playing the relevant sounds that are assigned to it.

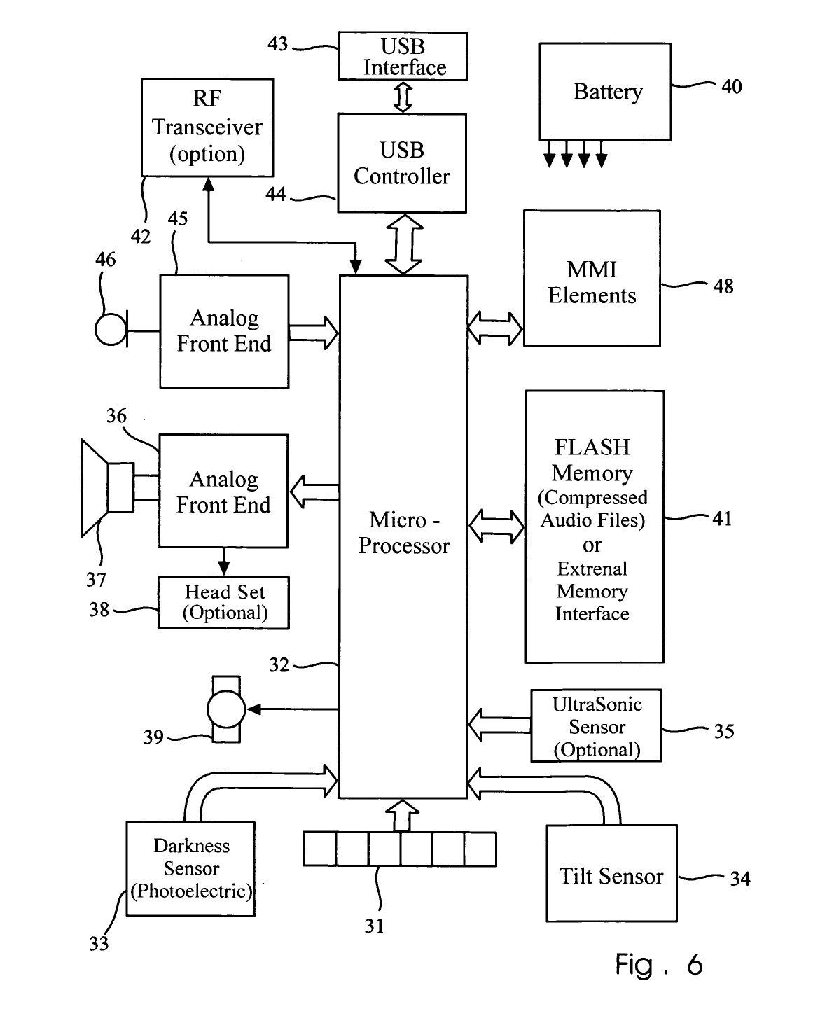

FIG. 6 details a block diagram of the reading device. An area of electrooptic sensor array 31 includes EO sensors in a bi-directional pattern, for example a Charge Coupled Device (CCD) array. Illumination means may also be included, to illuminate the label when ambient light is blocked by the reader device's body.

Sensors readings are transferred to a microprocessor 32, which recognizes each label when the device 2 is placed over that label.

The microprocessor 32 may comprise a one-chip microcontroller or a more powerful microcomputer or a Digital Signal Processor (DSP), as known in the art.

Darkness sensor 33, implemented with photoelectric sensors for example, may be used to indicate that the reading device is placed over the label—there is no ambient light reaching the lower part of the device. A suitable signal is transferred to the microprocessor 32.

Further sensors may include a tilt sensor 34 and/or an ultrasonic sensor 35 (optional).

Together, the sensors and microcomputer comprise the Labels Identification Head.

The microprocessor 32 processes the signals from the sensor array 31 and optionally from additional sensors as detailed above, to recognize the label the device is placed thereon, and to output an audio sequence corresponding to that label.

The audio is output through the output interface means 36 to the loudspeaker 37 or an optional head set 38, or to headphones.

A vibrator 39 may be used to indicate correct alignment of the reading device with a label (hit) or, in another embodiment, that there is a misalignment between reading device and label.

A battery 40 supplies electric power to the device. Either a primary battery or a secondary (rechargeable) battery may be used. The rechargeable battery may be charged when plugged into the computer through the USB interface.

Audio files may be stored in digital memory means 41, which may include for example solid state memory devices such as Flash memory, ROMs, PROMs or EEPROMS or a combination thereof.

Preferably, audio files are stored in a compressed form in the memory, to save memory space and thus to allow more information to be stored therein.

Other memory means may include magnetic memory devices, such as a mini disk or diskette, or optical means such as a CD.

Alternately, an interface to an external memory device may be used.

The audio files may be stored in a computer or PC (not shown), with a radio interface therewith, using for example an RF transceiver 42 (optional).

This feature allows to store a multitude of audio files, possibly for many books, in the computer. The files may also be updated by loading them into the computer using methods and means known in the art.

A demand for a specific file or part therein is transferred from the reading device to the computer, when a specific label is recognized (when the child places the device over that label).

The computer sends to the reading device the required audio file, which is then outputted using the loudspeaker 37.

The computer can play the applicable audio file using its own Speakers (instead of sending it back to the apparatus).

The device may interface with a computer or other input/output devices using an USB interface 43 with an optional USB controller 44.

An optional man-machine interface (HMI) 48 is used to control the device, and may include (not shown) an ON/OFF switch, volume control, status display, book select, etc.

Selecting between the different stored books may be done using the HMI elements 48, for example scrolling between the stored books is done through dedicated buttons in such a way that the selected book is displayed on the device's display (LCD) and/or the book's name is played and sounded using the integrated speaker.

An Ultrasonic Transceiver 35 may be used instead or in conjunction with the above mentioned sensors, in order to identify the position of the Identification Head relatively to the Label's surface. This positioning is achieved by analyzing the received reflected ultrasonic signal which was previously transmitted from the ultrasonic transceiver placed in the Identification Head.

Input interface means 45 to the microphone 46, allow a user's voice to be entered into the device—for example recording a father's voice or a mother's voice, to be subsequently activated when the child places the device over that label.

Method of Operation

1. The user turns ON the device using an On/Off slide switch.

2. After turned On, the device will perform a Built In Test (BIT), the result of the BIT will be indicated to the user through the HMI indicating/viewing elements.

3. The device will continuously look for a scenario indicating that the user has started to perform a Matching Sequence, this scenario will be referred to herein as the Matching Sequence Scenario.

The Matching Sequence is a serial sequence, the trigger to this sequence is a device movement identification by the device's processor.

4. The device movement identification may be achieved by using the embedded Tilt Sensor, this sensor generates multiple short circuit/open circuit states when moved, those multiple changing states are interpreted by the processor as a device movement.

5. After being triggered by the tilt sensor, the device's processor starts to look for the next following state which is referred to herein as the Darkness Identification state.

6. The Darkness Identification state which is the result of putting the Identification Head against the Label's surface (referred to as the Matching Sequence) is a state in which the Identification Head's surface is placed in a complete dark position as a result of the Label Matching sequence.

This state is identified by the photoelectric sensor which is placed on the Identification Head's surface, close to all other dual photoelectric sensors.

7. After the Darkness State was identified by the device's processor, the processor starts to look for Correct Label Matching State.

In order to establish Label Matching the device's processor starts to activate all the dual photoelectric sensors in order to identify correct label matching. Correct Label Matching is achieved when all the applicable sensors identify each, correct gray/color level and the sequential combination of all the identified gray levels produces a correct state (referred to as the Matching State) which represents a valid page number.

8. The sensors array, which is integrated in the Identification Head, includes extra dual photoelectric sensors (referred to as the redundancy sensors). The purpose of the redundancy sensors is to perform Authentication, meaning to eliminate the possibility to identify false matching states, by performing cross validation checkout to the identified sequential combination, in this way false alarms are eliminated.

The redundancy sensor's purpose is to identify certain gray levels or colors in accordance with the gray levels or colors which were already identified by the standard sensors, in such a way that Label Matching Criteria are met, in accordance with specific algorithms, corresponding to the Label's printed structure and shape.

9. After the Matching Sequence process has resulted in a Correct Valid Matching (referred to as HIT), the user is acknowledged by flashing Led (LCD), producing a typical vocal HIT sound and momentarily vibrating the device by activating the embedded vibrator.

10. These acknowledgments/feedback indicate HIT to the user and are followed by generation of prerecorded audio signal which matches the identified valid label.

End of Method.

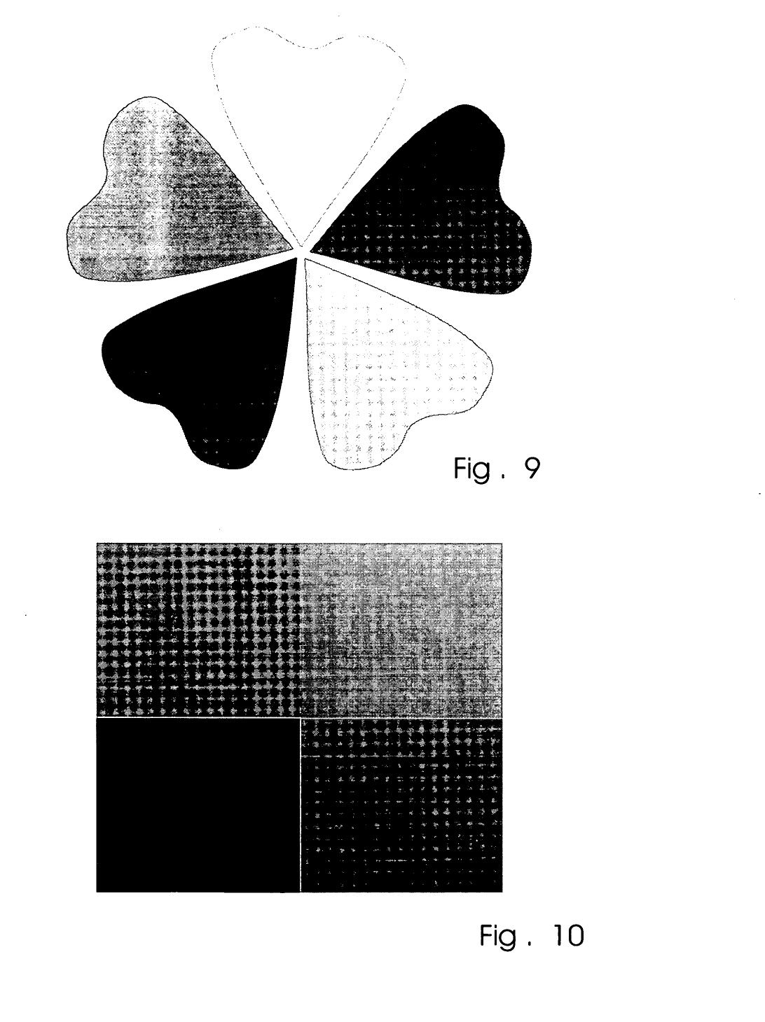

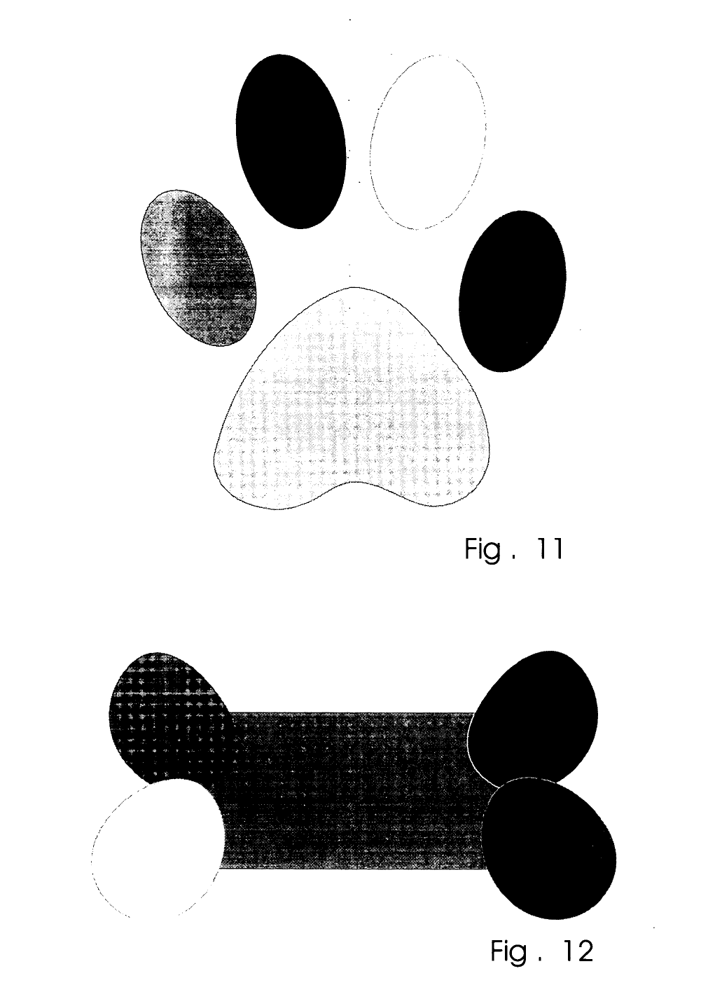

FIGS. 7 to 12 detail examples of the identification labels.

The printed labels are constructed in such a way that will enable proper encoding of at least 100 pages per book. For example, three dual photoelectric sensors (redundant sensors not included), each identifying 5 (five) gray levels will enable decoding of 5ˆ3=125 pages, after eliminating all the problematic combinations (all white, all black, etc.) proper identification of at least 100 pages is achieved. The relatively small amount of identifying sensors enables the user certain flexibility and variance when performing the Matching Sequence, which means that there is no need for precise Shape Matching between the Identification Head and the Label. For books which include more pages, further sensors need to be placed.

FIGS. 7 and 8 illustrate circular labels with a symmetric shape, the data on the label is stored as different colors and/or gray scale levels for the concentric rings, which may have the same width but a different average radius.

The other labels represents other examples for several of the possible identification label designs, in this case an asymmetric design with different symmetric and asymmetric shapes.

Preferably, the shape and size of the base of the lower part 22 of the reading device 2 is adapted to those of the label, for example a circular shape for the labels in FIGS. 7, 8 and 9, a rectangular shape for the label of FIG. 10, etc.

In another preferred embodiment, the labels may include a lenticular Flip image. A Flip is a lenticular effect that contains several images, each of the images can be seen only within a specific angle range. In this application, each image may contain different colors, different shades of gray between white and black, etc.

The Identification Head in this case will contain an array of electro-optical sensors, oriented in different angles corresponding to the lenticular label, in such a way as to enable each sensor to see a different image of the plurality of images in the lenticular image label.

This identification method may enable the system to have a larger tolerance in regard to label detection and also will enable the use of relatively small labels.

The above reading device may be adapted to various applications, and various alternate embodiments may be devised.

For example, the device may be used in Cookbooks, in order to guide the user step by step through the cooking procedure, while generating the relevant vocal instruction for each step using the device's HMI elements.

The invention may be used to teach different languages. The invention may be used to teach correct pronunciation of various words or sentences in a desired language, illustrating the language's phonetic principles.

The invention may be used to teach a child mathematics.

The invention, wherein the label is located inside a niche, enables easier matching between the Identification Head and the Label and easier identification of asymmetric labels.

The invention may be used as a way to identify products or elements, as an alternative way to the barcode method.

Apparatus Accessories may include LCD, Microphone, HMI elements such as scroll keys and USB interface.

These accessories will enable to record and edit the audio files directly into the apparatus and not through the Computer.

The child's parent records himself directly through the accessory , Edits the audio files into books and pages and downloads them into the apparatus using the USB interface.

It will be recognized that the foregoing is but one example of an apparatus and method within the scope of the present invention. Various modifications and other embodiments will occur to those skilled in the art, without undue experimentation, upon reading the disclosure set forth hereinbefore. The terminology employed herein should not be considered as limiting the invention, rather it is for describing specific embodiments only, and should be given their broadest interpretation.

The means for carrying out the various functions disclosed herein may take a variety of forms, without departing from the scope and spirit of the present invention.

What is claimed is:

1. A reading device comprising:
a. a handle or Grabbing surface;
b. a labels identification head and
c. means for outputting an audio sequence corresponding to each label being identified, wherein the label has bi-dimensional distinguishing features and the identification head includes a bi-dimensional sensors array adapted to read the distinguishing features in the label without scanning, when the device is placed over the label.

2. The reading device according to claim 1, wherein the base of the device has about the same size and shape as the label.

3. The reading device according to claim 2, wherein the base of the device is rectangular or circular.

4. The reading device according to claim 2, wherein each label has bi-dimensional optical distinguishing features and the identification head includes an electro-optical bi-dimensional sensor array.

5. The reading device according to claim 2, wherein the bi-dimensional optical distinguishing features in the labels include shapes having different colors or different shades of gray, or the shapes comprise concentric rings or rectangular areas.

6. The reading device according to claim 1, wherein the base of the device has a flat surface having the typical label's shape, in such a way as to enable placing the device over the label to allow identifying each specific label in an unambiguous manner.

7. A reading device comprising:
a. a handle so shaped as to provide easy and ergonomic grabbing by a child's hand;
b. an identification head located in the lower part of the device, for identifying each label when the identification head is placed over the label without scanning; and
c. audio generating means for generating predefined sounds for each identified label.

8. The reading device according to claim 7, wherein each label has bi-dimensional optical distinguishing features and the identification head includes an electro-optical bi-dimensional sensor array.

9. The reading device according to claim 8, wherein the label identification head further includes computer means for processing signals from the electro-optical bi-dimensional sensor array for labels identification.

10. The reading device according to claim 7, wherein the label identification head further includes transmitter means for sending signals from the electro-optical bi-dimensional sensor array to a computer, for labels identification.

11. The reading device according to claim 7, wherein the audio generating means includes a loudspeaker or headphones or headset.

12. The reading device according to claim 7, further including digital memory means for storing audio files corresponding to various labels in a book.

13. The reading device according to claim 7, further including a darkness sensor for sensing when the device is placed on a book's page.

14. The reading device according to claim 7, further including a tilt sensor.

15. The reading device according to claim 7, further including ultrasonic sensor means.

16. The reading device according to claim 7, further including HMI means for device activation and control.

17. A method for generating a preprogrammed audio sequence responsive to a label attached to a text or book or printed therein, comprising:
a. Looking continuously for a scenario indicating the start of performing a Matching Sequence;
b. after being triggered by a tilt sensor, a device's processor starting to look for the next following state;
c. detecting a complete dark position as a result of the Label Matching sequence, resulting from putting the Identification Head against the Label's surface;
d. the processor starting to look for Correct Label Matching State;
e. performing cross validation checkout to the identified sequential combination, to eliminate false alarms;
f. acknowledging the user by issuing a visual signal, a typical vocal HIT sound and momentarily vibrating the device by activating the embedded vibrator;
g. generating a prerecorded audio signal which matches the identified valid label.

18. The method for generating a preprogrammed audio sequence according to claim 17, wherein detecting a complete dark position by photoelectric sensor means placed on the Identification Head's surface, close to other dual photoelectric sensors.

19. The method for generating a preprogrammed audio sequence according to claim 17, wherein a processor starting to look for Correct Label Matching State by activating the dual photoelectric sensors in order to identify correct label matching, and wherein a Correct Label Matching is achieved when all the applicable sensors identify each correct gray/color level and the sequential combination of all the identified gray levels produces a correct state (referred to as the Matching State) which represents a valid page number.

20. The method for generating a preprogrammed audio sequence according to claim 17, wherein performing cross validation checkout to the identified sequential combination, to eliminate false alarms, using redundancy photoelectric sensors to perform Authentication.
